(19) United States
(12) Patent Application Publication
(10) Pub. No.: US 2009/0006690 A1
(43) Pub. Date: Jan. 1, 2009

(54) PROVIDING UNIVERSAL SERIAL BUS DEVICE VIRTUALIZATION WITH A SCHEDULE MERGE FROM MULTIPLE VIRTUAL MACHINES

(76) Inventors: Balaji Vembu, Folsom, CA (US); Nitin Sarangdhar, Portland, OR (US); Rajeev Nalawadi, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/769,576

(22) Filed: Jun. 27, 2007

(51) Int. Cl. G06F 13/362

(52) U.S. Cl. 710/113

(57) ABSTRACT

An apparatus, system, and method are disclosed. In one embodiment, the apparatus includes a virtualization engine on a computer platform. The virtualization engine can intercept multiple data transfer schedules from multiple virtual machines fetched from a memory by a physical Universal Serial Bus (USB) host controller on the computer platform. The virtualization engine also can merge the multiple fetched data transfer schedules into a merged data transfer schedule. The virtualization engine also can send the merged data transfer schedule to the physical USB host controller.

### FIELD OF THE INVENTION

The invention relates to Input/Output (I/O) virtualization performed on computer platforms. More specifically, the invention relates to merging the Universal Serial Bus (USB) data transfer schedules of multiple virtual machines running on a single computer platform before the schedules are consumed by a physical USB host controller.

### BACKGROUND OF THE INVENTION

Virtualized computer platforms are becoming popular for security purposes as well as for efficiency purposes. In a virtualized environment with multiple virtual machines (VMs) running on top of a virtual machine manager (VMM), the VMs need to share the input/output (I/O) devices connected to the computer platform.

The Universal Serial Bus (USB Specification Revision 2.0 (Apr. 27, 2000) has become an extremely popular I/O bus for today's computer platforms. Its plug-and-play versatility and fast transfer speeds offer a great deal of flexibility and thus, it is commonplace on most of today's computer platforms. A USB host controller hub, serves as the controller that controls one or more USB devices plugged into a computer platform. Each USB host controller typically supports up to 6 USB ports. Because of the need to support greater than the number of USB ports supported by one USB host controller and many I/O devices are USB devices, it is also common to have more than one USB host controller located in the platform. Each USB host controller may control typically six high speed USB devices. Thus, two or more USB host controller devices are located in the system to control the entire set of USB devices in the system. The USB host controller may control low speed or full speed USB devices compliant with USB 1.1 specification as well as high speed devices compliant with the USB 2.0 specification.

### BRIEF DESCRIPTION OF THE DRAWINGS

The present invention is illustrated by way of example and is not limited by the figures of the accompanying drawings, in which like references indicate similar elements, and in which:

FIGS. 1 and 2 describe one embodiment of a system and apparatus utilized to merge multiple virtual frame list schedules. Specifically FIG. 1 describes the significant hardware elements of the system and apparatus. FIG. 2 describes the key apparatus and system elements that include both hardware and software.

FIG. 3 describes one embodiment of the merging of two transfer descriptor schedules, one for each frame list corresponding to a virtual USB host controller.

FIG. 4 describes another embodiment of the merging of two transfer descriptor schedules, one for each frame list corresponding to a virtual USB host controller.

FIG. 5 is a flow diagram of one embodiment of a process to merge virtual frame lists in a virtualized environment.

### DETAILED DESCRIPTION OF THE INVENTION

Embodiments of an apparatus, system, and method to merge multiple universal serial bus device data transfer schedules in a virtualized environment are described. In the following description, numerous specific details are set forth. However, it is understood that embodiments may be practiced without these specific details. In other instances, well-known elements, specifications, and protocols have not been discussed in detail in order to avoid obscuring the present invention.

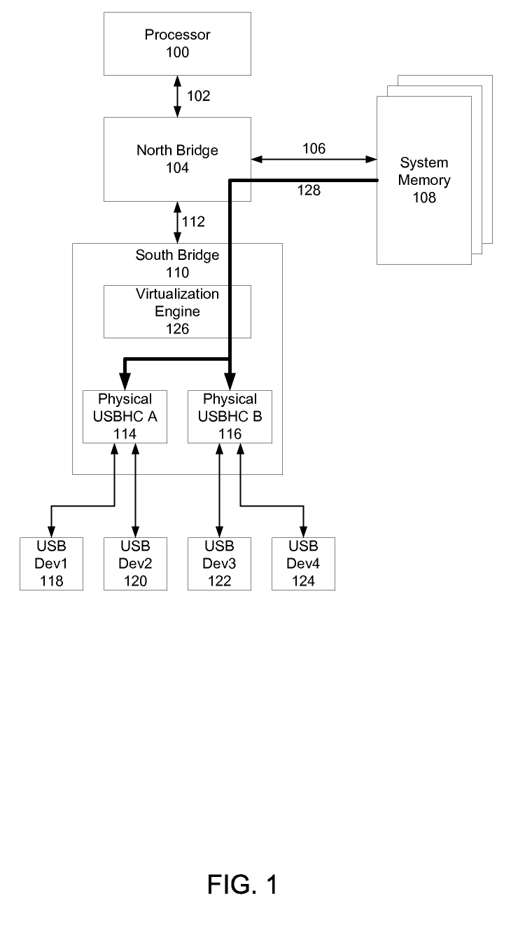

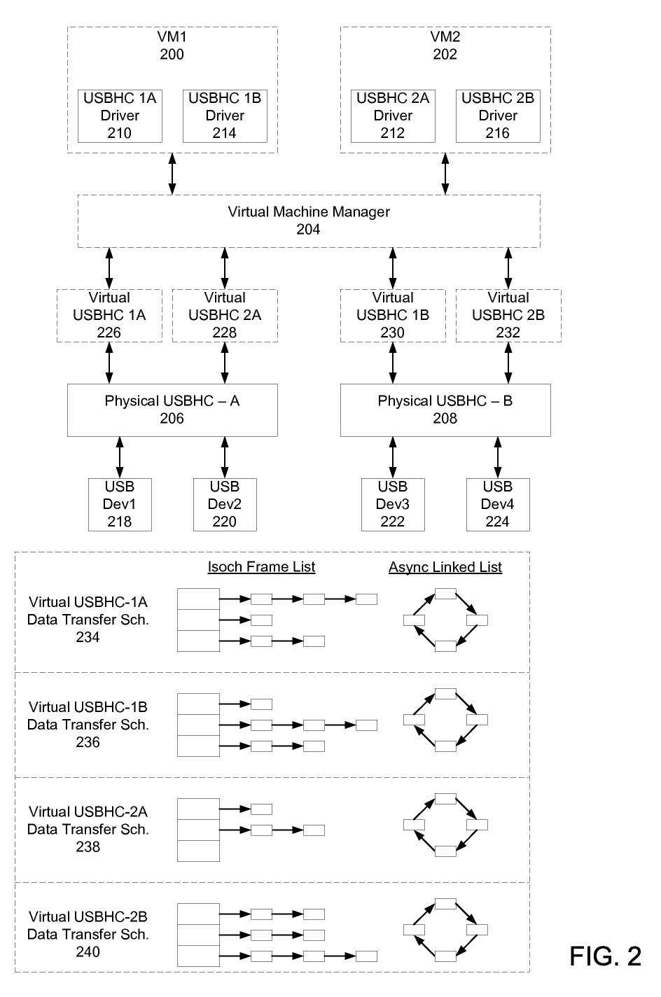

FIGS. 1 and 2 describe one embodiment of a system and apparatus utilized to merge multiple USB data transfer schedules. In FIG. 1, the system includes a processor 100 coupled to an interconnect 102. In different embodiments, the processor may include one or more processor cores. In some multiprocessor embodiments, there are multiple processor dies coupled together, each including one or more cores per die (the architecture for processor cores on multiple dies is not shown in FIG. 1). In different embodiments, the processor 100 may be any type of central processing unit (CPU) designed for use in any form of personal computer, handheld device, server, workstation, or other computing device available today.

The memory controller 104 is coupled to the interconnect 102. The interconnect 102 may be any type of interconnect that can send data from one device to another. In some embodiments, the inter-connect includes data, address, clock, and control lines used to transmit data (these lines are not shown). In some embodiments, the memory controller 104 is part of the chipset. In other embodiments, the memory controller is integrated into the processor 100. The memory controller controls system memory access. An additional interconnect 106 is coupled to the memory controller 104 as well as system memory 108. In some embodiments, interconnect 106 may utilize the same protocol as interconnect 102 as well as having the same data, address, clock, and control lines used to transmit data. In some embodiments, System memory 108 may be comprised of specific types of dynamic random access memory (DRAM), such as, for example, double data rate (DDR) synchronous DRAM. In some other embodiment the System memory 108 may be comprised of other memory type devices.

The memory controller 104 is coupled to an interconnect 112. An IO Controller 110 is also coupled to the interconnect 112. In some embodiments the IO controller may be part of the chipset. In other embodiments the IO controller may be integrated with the CPU or the memory controller or both. In different embodiments, the interconnect 112 may be any type of interconnect that can send data from one device to another. Again, in some embodiments, the interconnect 112 includes data, address, clock, and control lines used to transmit data (these lines are not shown). The IO Controller 112 controls the transfer of data between the processor 100, system memory 108 and any input/output (I/O) devices coupled to the IO Controller 112. In many embodiments, the IO Controller 110 is coupled to multiple I/O interconnects. In many embodiments, one of these interconnects is a universal serial bus (USB) interconnect. 132.

A USB host controller controls multiple USB devices coupled to the USB interconnect 132. With the proliferation of USB devices, it has become necessary to add multiple USB host controllers to be able to service a large number of USB devices coupled to a single system in a timely manner. Thus, in many embodiments, multiple USB host controller are integrated into the IO Controller 110, such as USB host controller A 114 and USB host controller B 116. In this example, USB host controller A 114 controls USB devices 1 and 2 (118 and 120) and USB host controller B 116 controls USB devices 3 and 4 (122 and 124).

In some embodiments the IO Controller 110 also has a virtualization engine 126. The virtualization engine allows the separation of the I/O system into multiple virtual I/O systems. where each system provides its own software interface to the operating system that controls it. The processor can switch execution between these multiple virtual systems. The virtualization engine 126 includes logic to effectively allow the rest of the computer system (including the I/O devices) to support multiple virtual systems.

FIG. 2 describes one embodiment of the virtual environment within the system utilized. The components in FIG. 2 that are in a solid outline are physical portions of the system as shown in FIG. 1 and the components in FIG. 2 that are in a dotted outline are not physical portions of the system, but are rather stored within the system memory. For ease of description, all of the components are shown together to show interoperability among components of the system and apparatus. The system described in FIG. 1 may be divided into two virtual machines (VM1 and VM2) (200 and 202 respectively). The virtual machine manager (VMM) 204 controls what system resources are available to any given VM at any given time. The VMM 204 directs the communication of VM1 200 and VM2 202 to each physical USB host controller in the system. In some embodiments, there are two physical USB host controller in the system (USB host controller A 206 and USB host controller B 208). To simplify the merging of data transfer schedules, each VM is required to have an operational driver for the USB host controller for communication and operational purposes. Thus, USB host controller A 206 has a driver in VM1 200 (USB host controller 1A Driver 210) and a driver in VM2 202 (USB host controller 2A Driver 212). Additionally, USB host controller B 208 has a driver in VM1 200 (USB host controller 1B Driver 214) and a driver in VM2 202 (USB host controller 2B Driver 216). The two USB host controller are termed “physical” USB host controllers because they actually exist as hardware integrated into the IO controller (110 in FIG. 1) of the computer system.

In some embodiments, USB host controller A 206 is coupled to USB Dev1 218 and USB Dev2 220 through the USB interconnect and USB host controller B 208 is coupled to USB Dev3 222 and USB Dev4 224 through the USB interconnect. In many embodiments, for each VM residing in the system, a virtual USB host controller is created in system memory for each physical USB host controller residing in the system. Thus, since there are two physical USB host controllers in the system in FIG. 2 (USB host controller A 206 and USB host controller B 208), a virtual USB host controller 1A 226 resides in memory to represent the physical USB host controller A 206 for VM1 200. A virtual USB host controller 1B 230 resides in memory to represent the physical USB host controller B 208 for VM1 200. A virtual USB host controller 2A 228 resides in memory to represent the physical USB host controller A 206 for VM2 202. And a virtual USB host controller 2B 232 resides in memory to represent the physical USB host controller B 208 for VM2 202.

Additionally, for each virtual USB host controller, a virtual data transfer schedule is stored in system memory. In many embodiments, this virtual data transfer schedule includes a virtual frame list that schedules isochronous traffic and a linked list of transfer descriptors that schedules asynchronous traffic. Within each frame of the virtual frame list a linked list of isochronous traffic transfer descriptors may also be present. This allows each physical USB host controller to transact with each VM. For example, if VM1 200 controls USB Dev1 and USB Dev3 (118 and 122 in FIG. 1), then VM1 200 must have a frame list for physical USB host controller A and physical USB host controller B (114 and 116 in FIG. 1) to allow operation of USB Dev1 and Dev3. Similarly, if VM2 202 controls USB Dev2 and USB Dev4 (120 and 124 in FIG. 1), then VM2 202 must also have a frame list for physical USB host controller A and physical USB host controller B (114 and 116 in FIG. 1) to allow operation of USB Dev2 and Dev4. These frame lists are shown in FIG. 2 as virtual USB host controller-1A frame list 234 (the frame list of virtual USB host controller 1A 226), virtual USB host controller-1B frame list 236 (the frame list of virtual USB host controller 1B 228), virtual USB host controller-2A frame list 238 (the frame list of virtual USB host controller 2A 230), and virtual USB host controller-2B frame list 240 (the frame list of virtual USB host controller 2B 232). A frame list includes a frame by frame isochronous data transfer transaction schedule for the virtual USB host controller for a given VM.

Each physical USB host controller (either USB host controller A 206 or USB host controller B 208 in FIG. 2) sends memory requests to the system memory (108 in FIG. 1) to obtain its transaction schedule from its frame list, which is in system memory. To service all the USB devices connected to a physical USB host controller, multiple data transfer schedules created by different VMs must be traversed. In the embodiment shown in FIG. 2, for each virtual USB host controller, a linked list of transfer descriptors (i.e. a transfer descriptor schedule) are sent to the corresponding physical USB host controller that sent the memory requests. Thus, in the case of physical USB host controller A 206, virtual USB host controller 1A 226 sends a transfer descriptor schedule pointed to by the first frame of the virtual USB host controller 1A frame list 234 and virtual USB host controller 2A 228 sends a transfer descriptor schedule pointed to by the first frame of the virtual USB host controller 2A frame list 238.

Additionally, after the isochronous transfer descriptor linked lists (pointed to by a single frame in each frame list) are merged, the lower priority asynchronous data transfer schedule linked lists may also be merged. Asynchronous traffic does not require as high of priority, thus, in many embodiments, asynchronous transfer descriptors from multiple virtual USB host controllers may be given a small percentage of the total frame time (e.g. 10% of the frame time versus the isochronous traffic receiving 90%). In other embodiments, the asynchronous traffic may be required to wait altogether from having any time for a given frame, and receive a portion of a frame's time from a subsequent frame. Thus, in some embodiments, isochronous traffic from the merged frame lists are linked together and the asynchronous transfer descriptors are then linked into the merged list of transfer descriptors after all linked isochronous transfers.

Returning to FIG. 1, these two transfer descriptor schedules (linked lists) are transmitted across interconnect 106, through the memory controller 104, across interconnect 112, and into the IO controller 110 (transmission path 128 illustrates the path the linked lists travel). Before the transfer descriptor schedules arrive at physical USB host controller A 114, they are intercepted in the virtualization engine 126. The virtualization engine 126 merges the two transfer descriptor schedules into a merged transfer descriptor schedule (i.e. the two linked lists are merged into one larger linked list). This merged transfer descriptor schedule is then sent to physical USB host controller A 114 to be operated on for a particular frame.

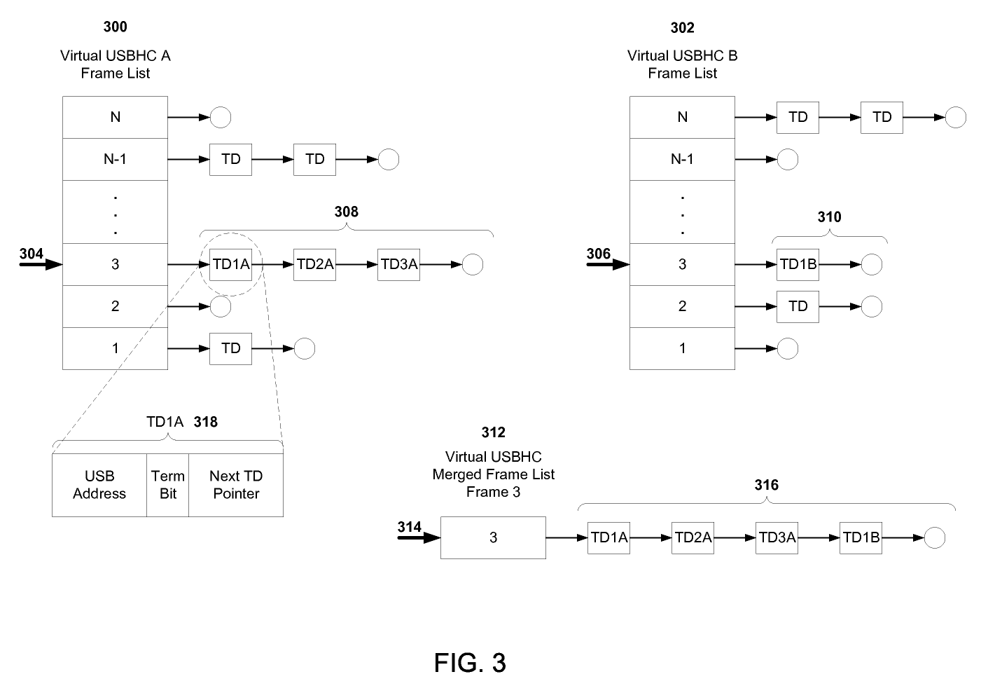

FIG. 3 describes one embodiment of the merging of two transfer descriptor schedules, one for each frame list corresponding to a virtual USB host controller. In one embodiment, the merge portion of the example discussed above, where the two transfer descriptor schedules are merged in the virtualization engine and then sent to physical USB host controller A as a merged transfer descriptor schedule, is shown in FIG. 3. In many embodiments, two virtual USB host controller frame lists are shown (the frame list for USB host controller A 300 and the frame list for USB host controller B 302). Each frame list includes a list of individual frames (1-N where N equals the number of frames in the frame list). Each individual frame either has a pointer to the first transfer descriptor in a transfer descriptor schedule, or a null pointer (designated by a circle). Additionally, the virtualization engine maintains a frame list pointer (304 for USB host controller A and 306 for USB host controller B) that points to the frame in the list where the virtual USB host controller is operating. In many embodiments, the virtualization engine operates one, two, or three frames ahead of the corresponding physical USB host controller. In some embodiments, each frame is given a maximum segment of time that the USB host controller can work on the list. Thus, for example, if the segment of time per frame is 125 μS (125 microseconds), then after 125 μS the virtual USB host controller will stop executing anything in the linked list pointed to by the current frame list pointer location, increment the frame list pointer to the next frame in the frame list, and start executing at that frame location.

In many embodiments, the two frame lists (the USB host controller A frame list 300 and the USB host controller B frame list 302) are synchronized in time, so frame list pointers 304 and 306 point to the same frame in their respective frame lists. Thus, in this example, frame list pointers 304 and 306 point to frame 3 in each respective frame list. Frame 3 in the frame list for USB host controller A points to a transfer descriptor schedule (linked list 308) that is three transfer descriptors long (TD1A, TD2A, and TD3A) followed by a null pointer. Frame 3 in the frame list for USB host controller B points to a transfer descriptor schedule (linked list 310) that is one transfer descriptor long (TD1B) followed by a null pointer. In some embodiments the two frame lists are not synchronized. In these embodiments, the frame list pointer 304 may point to frame 3 in virtual USB host controller A frame list 300, while frame list pointer 306 may point to frame 0 in virtual USB host controller A frame list 302.

In many embodiments, when the virtualization engine (126 in FIG. 1) receives these two transfer descriptor schedules that need to be merged, it traverses the first transfer descriptor schedule (traverses the linked list) 308. Each transfer descriptor in the linked list has a terminate bit. In many embodiments, if the terminate bit is clear for a given transfer descriptor, that transfer descriptor is not the final transfer descriptor in the linked list and an address pointing to the next transfer descriptor will be included as part of the transfer descriptor. Otherwise, if the terminate bit is set, that transfer descriptor is the final transfer descriptor in the linked list and a null pointer will be included instead of the address.

Thus, as the virtualization engine traverses the first linked list 308, it checks the terminate bit at each transfer descriptor to find the last transfer descriptor. Once the virtualization engine finds the last transfer descriptor (TD3A) in the first linked list 308, it clears the terminate bit (in TD3A) and inputs the address of the first transfer descriptor in the transfer descriptor linked list for USB host controller B (TD1B). Thus, the address in TD3A points to TD1B. TD1B still points to null pointer it originally pointed to. After this modification, the virtualization engine has created a new frame 3 in a merged frame list 312. Merged frame list pointer 314 points to the new merged frame 3. And the new merged frame 3 points to the merged transfer descriptor schedule 316. The merged transfer descriptor schedule 316 is sent by the virtualization engine to physical USB host controller A to be operated on. The merging can be performed in a just-in-time manner (on the fly) by the virtualization engine. When the merging is performed on the fly, the virtualization does not create a merged physical list, rather it just sends the newly merged data transfer schedules directly to the physical USB host controller per frame.

In some embodiments, VM1 and VM2 may use different USB addresses to access the physical USB devices. In such embodiments, a translation table is maintained per VM to store the corresponding virtual USB address for a given physical USB address. Each transfer descriptor has at least a USB address, a termination bit, and a pointer to a next transfer descriptor (if one exists—otherwise it has a null pointer). The specific details of a transfer descriptor are shown in FIG. 3 item 318, specifically this is TD3A in the virtual USB host controller A frame list. The USB address is part of the transfer descriptor content and the USB host controller 1A driver will use a virtual USB address to address the USB device with a different physical USB address. The virtualization engine will perform the translation of virtual USB address to physical USB address as part of the merge operation.

In many embodiments, the transfer descriptor schedules are sent on a frame by frame basis to a target USB host controller. In these frame by frame embodiments, the virtualization engine merges the linked lists in a just-in-time manner. In other words, the virtualization engine is creating each merged linked list only one, two, or three frames in advance—right before they will be operated on by the physical USB host controller.

FIG. 3 specifically describes an embodiment that has isochronous USB traffic, such as a video camera live feed. There also could be asynchronous USB traffic present in the system, such as a printer driver sending a print job to a USB printer. Isochronous traffic is the most crucial traffic to maintain real-time throughput or the quality of the device communication could deteriorate and adversely affect a user's experience (e.g skipped frames in a video application lead to a choppy picture). Thus, the isochronous streams are operated on and merged first. Though, if there are empty frames, or frames that are not full of isochronous traffic, then the virtualization engine will also merge asynchronous traffic. The merging process is similar, except the linked lists of transfer descriptors seen in isochronous traffic gives way to a pool of asynchronous transfer descriptors.

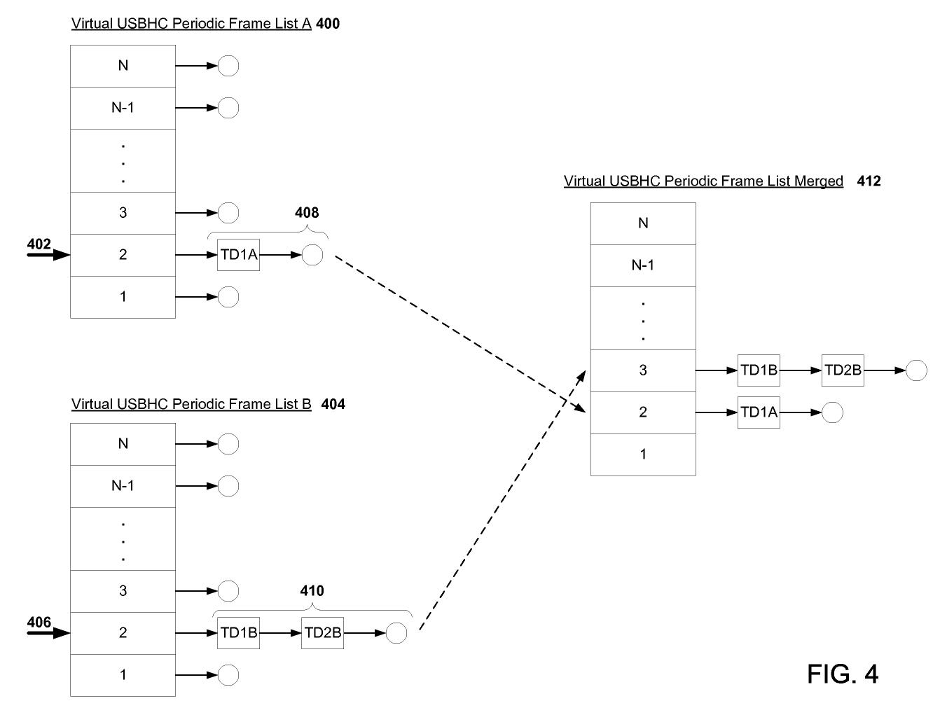

FIG. 4 describes another embodiment of the merging of two transfer descriptor schedules, one for each frame list corresponding to a virtual USB host controller. FIG. 4 describes an example embodiment where many of the frames in each frame list are empty (i.e. pointing directly to null pointers). In a situation where there are many free frames in any given frame list, the virtualization engine may merge two frame lists by merging linked list frames from one frame list with empty frames on the other frame list. In other words, for any given frame pointed to by a frame list pointer, if neither frame has a linked list then nothing happens. If one of the two frames has a linked list and the other frame is empty, then the frame with the linked list is, in essence, merged with the empty frame to create a combined linked list that comprises both frames (though it is actually just the linked list that was in the single frame). If both frames have linked lists, then the virtualization engine must determine whether the next frame in both frame lists is empty. If the next frames in both frame lists are empty, then one of the two linked lists stays at the initial frame location of the merged frame list and the other linked list is moved to the adjacent empty frame location of the merged frame list.

Specifically turning to FIG. 4, virtual USB host controller A frame list 400 contains a list of frames (1-N) and the frame list pointer 402 for virtual USB host controller A frame list 400 points to frame 2. Virtual USB host controller B frame list 404 contains a list of frames (1-N) and the frame list pointer 406 points to frame 2 as well (this would be the case if the two frame lists were synchronized in time).

Frame list pointer 402 points to a transfer descriptor schedule (a linked list of transfer descriptors) 408 that includes only TD1A. Frame list pointer 402 points to a transfer descriptor schedule 410 that include TD1B and TD2B. In this example, the virtualization engine determines that frame 2 in both frame lists has a transfer descriptor linked list. Once the virtualization engine makes this determination, then it checks the next position in each frame list past the current frame list pointers (402 and 406), namely frame 3 in each frame list. At this point the virtualization engine checks to see if linked lists exist in either frame 3. When it determines that both frame 3's are empty, the virtualization engine then sends linked list 408 from frame 2 in virtual USB host controller A frame list during the time that the physical USB host controller assumes it is receiving the linked list from all frame 2's. After the physical USB host controller operates on linked list 408 during the frame 2 time period, then the frame list pointers increment and the virtualization engine sends linked list 410 to the physical USB host controller during the frame 3 time period. The new virtual USB host controller merged frame list 412 is shown after the merge operation takes place.

If two or more consecutive frames for both frame lists have linked lists, then, in some embodiments, the virtualization engine would be required to push back the linked lists associated with the second consecutive frame to the third frame and so on to maintain the correct order of operations.

In many embodiments, upon system initialization, the virtualization engine will map each device coupled to a physical USB host controller to a particular virtual USB host controller. In the embodiment described above in reference to FIG. 2, where USB Dev1 and Dev3 are owned by VM1 and USB Dev2 and Dev4 are owned by VM2, the virtualization engine would perform the following mappings after the virtual USB host controllers are running in the system. The virtualization engine will expose Dev1 218 to virtual USB host controller 1A 226. Then the virtualization engine will expose Dev3 222 to virtual USB host controller 1B 230. Then the virtualization engine will expose Dev2 218 to virtual USB host controller 2A 228. Finally the virtualization engine will expose Dev4 224 to virtual USB host controller 1A 232. In many embodiments, this process is performed based on a predefined configuration or user interaction to determine which device needs to be exposed to which VM.

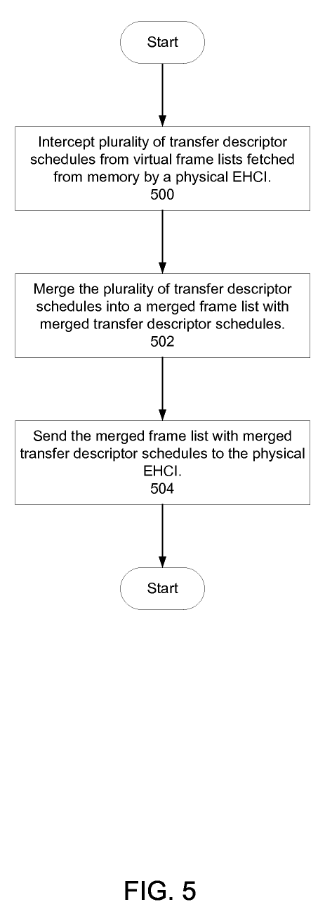

FIG. 5 is a flow diagram of one embodiment of a process to merge virtual frame lists in a virtualized environment. In some embodiments, the process is performed by processing logic within a virtualization engine Referring to FIG. 5, the process begins by processing logic intercepting a plurality of transfer descriptor schedules from a plurality of virtual frame lists fetched from memory by a first physical USB host controller (processing block 500). Next, processing logic merges the plurality of fetched transfer descriptor schedules from the plurality of virtual frame lists into a merged frame list with merged transfer descriptor schedules (processing block 502). Finally, processing logic sends the merged frame list with merged transfer descriptor schedules to the first physical USB host controller (processing block 504) and the process is finished. The merging process is described in detail above in the discussion regarding FIGS. 3 and 4.

Thus, embodiments of an apparatus, system, and method to merge multiple universal serial bus device virtual frame list schedules in a virtualized environment are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. An apparatus, comprising:
a virtualization engine on a computer platform, the virtualization engine to
intercept a plurality of data transfer schedules from a plurality of virtual machines fetched from a memory by a physical Universal Serial Bus (USB) host controller on the computer platform;
merge the plurality of fetched data transfer schedules into a merged data transfer schedule; and
send the merged data transfer schedule to the physical USB host controller.

2. The apparatus of claim 1, wherein each of the plurality of data transfer schedules comprises a virtual frame list of transfer descriptor linked lists for isochronous traffic.

3. The apparatus of claim 2, wherein each of the plurality of data transfer schedules further comprises a linked list of asynchronous transfer descriptors.

4. The apparatus of claim 2, wherein the virtualization engine is further operable to merge the plurality of fetched virtual frame lists on a per frame basis in a just-in-time manner.

5. The apparatus of claim 4, wherein the virtualization engine is further operable to
traverse a first transfer descriptor linked list pointed to by a first frame of a first virtual frame list;
determine a final transfer descriptor in the first linked list by checking whether a terminate bit is set in each transfer descriptor in the first linked list;
clear the terminate bit in the final transfer descriptor in the first linked list; and
link the final transfer descriptor in the first linked list to a first transfer descriptor pointed to by a first frame of a second virtual frame list.

6. The apparatus of claim 4, wherein the virtualization engine is further operable to
inspect two consecutive frames of a first virtual frame list and two consecutive frames of a second virtual frame list;
determine that the first of the two consecutive frames for each virtual frame list contain a transfer descriptor linked list and the second of the two consecutive frames for each virtual frame list do not contain a transfer descriptor linked list;
send the transfer descriptor linked list pointed to by the first frame of the first virtual frame list to the physical USB host controller when the physical USB host controller requests the first of the two consecutive frames from both the first and second virtual frame lists;
send the transfer descriptor linked list pointed to by the first frame of the second virtual frame list to the physical USB host controller when the physical USB host controller requests the second of the two consecutive frames from both the first and second virtual frame lists.

7. The apparatus of claim 1, wherein the virtualization engine is further operable to map a device coupled to the physical USB to one of a plurality of virtual USB host controllers.

8. The apparatus of claim 1, wherein the virtualization engine is further operable to
translate one or more virtual USB addresses within at least one of the one or more data transfer schedules to one or more physical USB addresses.

9. A system, comprising:
an interconnect;
a processor coupled to the interconnect;
a memory coupled to the interconnect, the memory to store a virtual machine manager, a plurality of virtual machines, and a plurality of virtual frame lists, wherein each virtual frame list comprises a schedule of operations for one of a plurality of universal serial bus (USB) devices;
a chipset coupled to the interconnect;
a physical USB host controller, integrated in the chipset, the physical USB host controller to control one or more of the plurality of USB devices;
a virtualization engine, integrated in the chipset, the virtualization engine to
intercept a plurality of data transfer schedules from a plurality of virtual machines fetched from a memory by a physical Universal Serial Bus (USB) host controller on the computer platform;
merge the plurality of fetched data transfer schedules into a merged data transfer schedule; and
send the merged data transfer schedule to the physical USB host controller.

10. The system of claim 9, wherein each of the plurality of data transfer schedules comprises a virtual frame list of transfer descriptor linked lists for isochronous traffic.

11. The system of claim 10, wherein each of the plurality of data transfer schedules further comprises a linked list of asynchronous transfer descriptors.

12. The system of claim 10, wherein the virtualization engine is further operable to merge the plurality of fetched virtual frame lists on a per frame basis in a just-in-time manner.

13. The system of claim 12, wherein the virtualization engine is further operable to
traverse a first transfer descriptor linked list pointed to by a first frame of a first virtual frame list;
determine a final transfer descriptor in the first linked list by checking whether a terminate bit is set in each transfer descriptor in the first linked list;
clear the terminate bit in the final transfer descriptor in the first linked list; and
link the final transfer descriptor in the first linked list to a first transfer descriptor pointed to by a first frame of a second virtual frame list.

14. The system of claim 9, wherein the virtualization engine is further operable to
translate one or more virtual USB addresses within at least one of the one or more data transfer schedules to one or more physical USB addresses.

15. A method, comprising:
intercepting a plurality of data transfer schedules from a plurality of virtual machines fetched from a memory by a physical Universal Serial Bus (USB) host controller on the computer platform;
merging the plurality of fetched data transfer schedules into a merged data transfer schedule; and
sending the merged data transfer schedule to the physical USB host controller.

16. The method of claim 15, wherein each of the plurality of data transfer schedules comprises a virtual frame list of transfer descriptor linked lists for isochronous traffic.

17. The method of claim 16, wherein each of the plurality of data transfer schedules further comprises a linked list of asynchronous transfer descriptors.

18. The method of claim 16, further comprising:
merging the plurality of fetched virtual frame lists on a per frame basis in a just-in-time manner.

19. The method of claim 18, further comprising:
traversing a first transfer descriptor linked list pointed to by a first frame of a first virtual frame list;
determining a final transfer descriptor in the first linked list by checking whether a terminate bit is set in each transfer descriptor in the first linked list;
clearing the terminate bit in the final transfer descriptor in the first linked list; and
linking the final transfer descriptor in the first linked list to a first transfer descriptor pointed to by a first frame of a second virtual frame list.

20. The method of claim 15, further comprising
translating one or more virtual USB addresses within at least one of the one or more data transfer schedules to one or more physical USB addresses.
